(19) United States
(12) Patent Application Publication
(10) Pub. No.: US 2007/0046573 A1
(43) Pub. Date: Mar. 1, 2007

(54) Driving method of plasma display panel (PDP)

(76) Inventor: Jong-Wook Kim, Suwon-si (KR)

Correspondence Address: Robert E. Bushnell, Suite 300, 1522 K Street, N.W., Washington, DC, 20005-1202, US

(21) Appl. No.: 11/499,657

(22) Filed: Aug. 7, 2006

(30) Foreign Application Priority Data
Aug. 27, 2005 (KR) 10-2005-0079124

(51) Int. Cl. G09G 3/28

(52) U.S. Cl. 345/63

(57) ABSTRACT

A display panel has a plurality of pixels, each of the pixels comprising two green cells, a red cell and a blue cell. The red cell or the blue cell is disposed between the two green cells. The display panel uses red-green-blue gray level data with respect to each of the pixels. A method of driving the display panel comprises: (a) summing red gray level data for two adjacent pixels of the red-green-blue gray level data, and applying the summation result to the red cell; (b) applying green gray level data for the two adjacent pixels of the red-green-blue gray level data to the two green cells; and (c) summing blue gray level data for the two adjacent pixels for the red-green-blue gray level data, and applying the summation result to the blue cell.

### CLAIM OF PRIORITY

This application makes reference to, incorporates the same herein, and claims all benefits accruing under 35 U.S.C. § 119 from an application earlier filed for DISPLAY PANEL HAVING EFFICIENT PIXEL STRUCTURE, AND METHOD FOR DRIVING THE DISPLAY PANEL in the Korean Intellectual Property Office on the 27 of Aug. 2005 and there duly assigned Serial No. 10-2005-0079124.

### BACKGROUND OF THE INVENTION

1. Technical Field

The present invention relates to a display panel and a driving method thereof, and more particularly, to a display panel with an efficient pixel structure and a driving method thereof.

2. Related Art

Conventional display panels, for example, the plasma display panel disclosed in U.S. Pat. No. 6,900,591, have a structure in which each pixel consists of a red cell, a blue cell, and a green cell.

In order to enhance the resolution of a display panel with the conventional pixel structure described above, it is necessary to reduce cell areas formed by driving electrode lines or to increase the entire size of the display panel. However, a limitation exists in reducing cell areas formed by driving electrode lines.

Accordingly, if cell areas are constant, the resolution of a display panel with the conventional pixel structure described above is proportional to the entire size of the display panel.

### SUMMARY OF THE INVENTION

The present invention provides a display panel which is capable of achieving a high resolution without increasing the entire size of the display panel.

The present invention also provides a method for driving a display panel using R(Red)-G(Green)-B(Blue) gray level data with respect to a pixel.

According to an aspect of the present invention, a display panel has a plurality of pixels, each of the pixels comprising two green cells, a red cell, and a blue cell, wherein the red cell or the blue cell is disposed between the two green cells.

In the display panel according to the present invention, the number of green cells in a pixel is double the number of red or blue cells in the pixel. In this regard, the actual resolution which can be visually recognized by human beings is nearly proportional to the number of green cells having a relatively high brightness. Accordingly, in the plasma display panel according to the present invention, the number of cells increases 4/3 times while the resolution is doubled, in contrast to a display panel with a conventional pixel structure.

Accordingly, if the entire size and cell areas of the display panel according to the present invention are equal to the entire size and cell areas, respectively, of the conventional display panel, the actual resolution which can be visually recognized from the display panel by human beings can increase 3/2 times compared to the resolution of the conventional display panel.

According to another aspect of the present invention, a method of driving a display panel having a plurality of pixels is provided, the display panel using red-green-blue gray level data with respect to each of the pixels, each of the pixels comprising two green cells, a red cell, and a blue cell, and the red cell or the blue cell being disposed between the two green cells. The method comprises: (a) summing red gray level data for two adjacent pixels of the red-green-blue gray level data, and applying the summation result to the red cell; (b) applying green gray level data for the two adjacent pixels of the red-green-blue gray level data to the two green cells; and (c) summing blue gray level data for the two adjacent pixels for the red-green-blue gray level data, and applying the summation result to the blue cell.

In the driving method of the display panel according to the present invention, a display panel with a pixel structure of green-red-green-blue can be driven using all gray level data of red-green-blue.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a plasma display apparatus according to an embodiment of the present invention;

FIG. 2 is a diagram for explaining a process for transforming a pixel structure of a conventional plasma display panel into a pixel structure of the plasma display panel illustrated in FIG. 1;

FIG. 3 is a diagram showing the arrangement state of electrode lines in the plasma display panel illustrated in FIG. 1;

FIG. 4 is a perspective view showing the entire internal structure of the plasma display 11 panel illustrated in FIG. 1;

FIG. 5 is a cross-sectional view of an exemplary cell in the plasma display panel illustrated in FIG. 4;

FIG. 6 is a flowchart illustrating an operation in which gray level data is processed by a controller illustrated in FIG. 1;

FIG. 7 is a timing diagram for explaining a method of driving the plasma display panel illustrated in FIG. 1; and

FIG. 8 shows waveform diagrams of signals applied to electrode lines of the plasma display panel illustrated in FIG. 1 in a unit subfield illustrated in FIG. 7.

### DETAILED DESCRIPTION OF THE INVENTION

The present invention will now be described more fully with reference to the accompanying drawings, in which exemplary embodiments of the invention are shown.

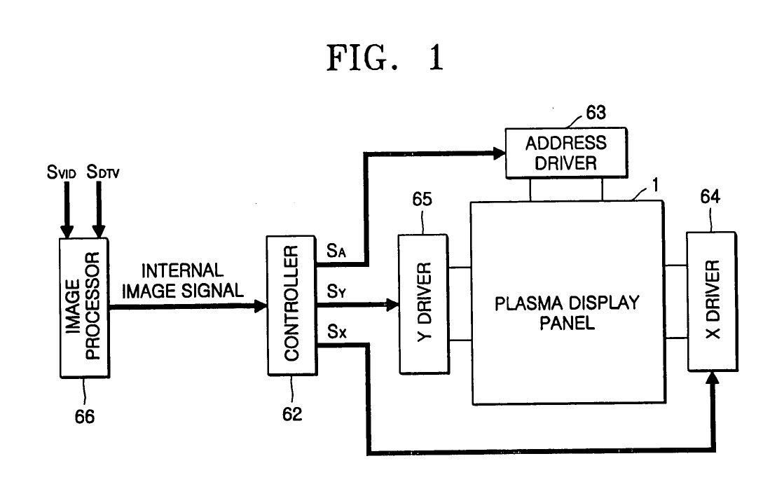

FIG. 1 is a block diagram of a plasma display apparatus according to an embodiment of the present invention.

Referring to FIG. 1, the plasma display apparatus includes a plasma display panel 1, an image processor 66, a controller 62, an address driver 63, an X driver 64, a Y driver 65, and a power supply (not shown).

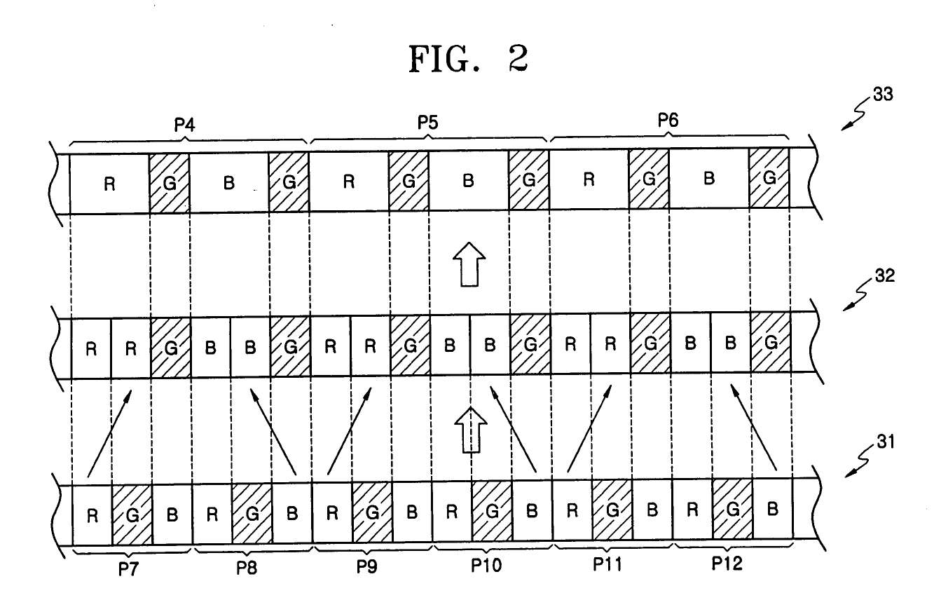

In the plasma display panel 1, a pixel includes two green cells, a red cell and a blue cell, and the red cell, or the blue cell is disposed between the two green cells. A detailed description regarding this will be given later with reference to FIGS. 2 thru 5.

The image processor 66 transforms external image signals, for example, a video signal S_{VID} and a digital TV signal S_{DTV}, into internal image signals which are digital signals. In this regard, the internal image signals include, for example, red, green and blue gray level data, each consisting of 8 bits, a clock signal, and vertical and horizontal synchronization signals, with respect to each pixel.

The controller 62 generates data signals S_{A}, X control signals S_{X}, and Y control signals S_{Y}, in response to the internal image signals received from the image processor 66. The red-green-blue gray level data received from the image processor 66 is processed so as to be suitable for the plasma display panel 1 with a pixel structure of green-red-green-blue. A data processing method for processing the red-green-blue gray level data will be described in detail later with reference to FIGS. 2 thru 6.

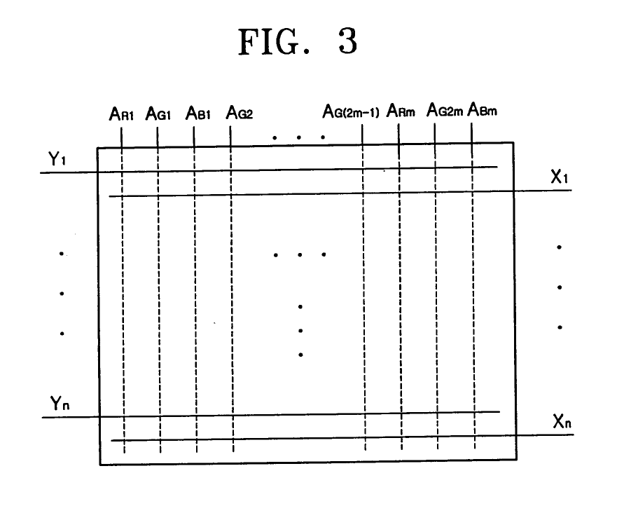

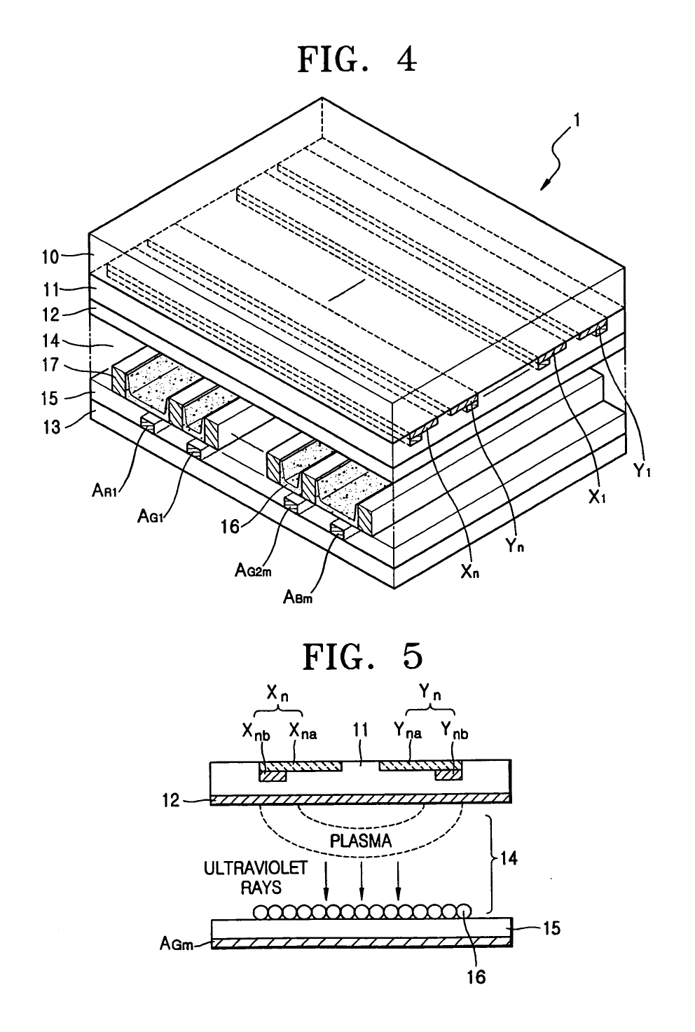

The address driver 63 drives address electrode lines (ARI, A_{G1}, A_{B1}, A_{G2}, . . . , A_{G2m} and A_{Bm} of FIGS. 3 and 4) of the plasma display panel 1 according to the data signals S_{A} received from the controller 62. The X driver 64 drives X electrode lines X₁ (X₁, . . . , Xₙ of FIGS. 3 and 4) according to the X control signals S_{X} received from the controller 62. The Y driver 65 drives Y electrode lines (Y₁, . . . , Yₙ of FIGS. 3 and 4) according to the Y control signals S_{X} received from the controller 62.

FIG. 2 is a diagram for explaining a process for transforming a pixel structure of a conventional plasma display panel into a pixel structure of the plasma display panel illustrated in FIG. 1.

Referring to FIG. 2, in the pixel structure 31 of the conventional plasma display panel, a pixel (one of pixels P7 through P12) includes a red cell, a green cell and a blue cell. That is, the conventional plasma display panel has a pixel structure 31 of red-green-blue.

However, in the pixel structure 33 of the plasma display panel 1 according to the present invention, a pixel (one of pixels P4, P5 and P6) includes two green cells, a red cell and a blue cell, and the red cell or the blue cell is disposed between the two green cells. That is, the plasma display panel 1 illustrated in FIG. 1 has a pixel structure 33 of green-red-green-blue.

In the plasma display panel 1 with the pixel structure 33, the number of green cells in a pixel is double the number of red or blue cells. In this respect, the actual resolution which can be visually recognized by human beings is nearly proportional to the number of green cells having a relatively high brightness. Accordingly, in the plasma display panel 1 with the pixel structure 33 according to the present invention, the number of cells increases 4/3 times while the resolution is doubled, in contrast to the conventional display panel with the general pixel structure.

If the entire size and cell areas of the display panel 1 having the pixel structure 33 of green-red-green-blue are equal to the entire size and cell areas, respectively, of the conventional display panel, the actual resolution which can be visually recognized from the display panel 1 by human beings can increase 3/2 times compared to the resolution of the conventional display panel.

If the format of an external image signal, for example, a gray level signal included in a video signal (S_{VID} of FIG. 1) or a digital TV signal (S_{DTV} of FIG. 1), corresponds to the conventional pixel structure 31 of red-green-blue, gray level data among internal image signals input to the controller 62 (FIG. 1) must be processed to correspond to the pixel structure 33 of green-red-green-blue according to the present invention.

In detail, red gray level data R for two adjacent pixels P7-P8, P9-P10, or P11-P12 of the gray level data are summed, and the summation result R+R is applied to a red cell. Also, green gray level data G for the two adjacent pixels P7-P8, P9-P10, or P11-P12 of the gray level data are respectively applied to two green cells. Then, blue gray level data B for the two adjacent pixels P7-P8, P9-P10, or P11-P12 of the gray level data are summed, and the summation result B+B is applied to a blue cell.

Accordingly, the display panel 1 having the pixel structure 33 of green-red-green-blue can be driven using all gray level data of red-green-blue.

Furthermore, the following process is needed to quickly perform the data processing described above.

First, gray level data corresponding to the conventional pixel structure 31 of red(R)-green(G)-blue(B)-red(R)-green(G)-blue(B) is rearranged to correspond to a virtual pixel structure 32 of red(R)-green(G)-blue(B)-blue(B)-green(G)-red(R).

Then, two red gray level data R which become adjacent to each other by the rearrangement are summed, and the summation result R+R is applied to a red cell. Also, green gray level data G for two adjacent pixels of the gray level data are respectively applied to two green cells. Two blue gray level data B which become adjacent to each other by the rearrangement are summed, and the summation result B+B is applied to a blue cell.

FIG. 3 is a diagram showing the arrangement state of electrode lines in the plasma display panel 1 illustrated in FIG. 1; FIG. 4 is a perspective view showing the entire internal structure of the plasma display panel illustrated in FIG. 3; and FIG. 5 is a cross-sectional view of an exemplary cell in the plasma display panel illustrated in FIG. 4.

Referring to FIGS. 3, 4 and 5, address electrode lines A_{R1}, A_{G1}, A_{B1}, A_{G2}, . . . , A_{G2m} and ABm, upper and lower dielectric layers 11 and 15, Y electrode lines Y₁, . . . , Yₙ, X electrode lines X₁, . . . , Xₙ, phosphor layers 16, barrier ribs 17, and an MgO layer 12 which is a protection layer are provided between the front and rear glass substrates 10 and 13, respectively, of the plasma display panel 1 illustrated in FIGS. 1 and 4.

The address electrode lines A_{R1}, A_{G1}, A_{B1}, A_{G2}, . . . , A_{G2m} and A_{Bm} are formed with a predetermined pattern on the upper surface of the rear glass substrate 13. The lower dielectric layer 15 covers the address electrode lines A_{R1}, A_{G1}, A_{B1}, A_{G2}, . . . , A_{G2m} and A_{Bm}. The barrier ribs 17 are formed parallel to the address electrode lines A_{R1}, A_{G1}, A_{B1}, A_{G2}, . . . , A_{G2m} and A_{Bm} on the lower dielectric layer 15. The barrier ribs 17 partition discharge areas of cells, and prevent cross talk between respective cells. The phosphor layers 16 are formed between the respective barrier ribs 17.

The X electrode lines X₁, . . . , Xₙ and Y electrode lines Y₁, . . . , Yₙ are formed with a predetermined pattern on the lower surface of the front glass substrate 10 in such a manner as to intersect the address electrode lines A_{R1}, A_{G1}, A_{B1}, A_{G2}, . . . , A_{G2m} and A_{Bm}. Each intersection forms a cell. Referring to FIG. 5, the X electrode lines X₁, . . . , Xₙ and the Y electrode lines Y₁, . . . , Yₙ are formed by coupling transparent electrode lines Xₙₐ and Yₙₐ, respectively, made of a transparent conductive material such as Indium Tin Oxide (ITO), with metal lines X_{nb} and Y_{nb}, respectively, so as to increase conductivity. The front dielectric layer 11 is formed so as to cover the rear surfaces of the X electrode lines X₁, . . . , Xₙ and the Y electrode lines Y₁, . . . , Yₙ. The protection layer 12 (for example, an MgO layer) for protecting the plasma display panel 1 from a strong field is formed on the lower surface of the front dielectric layer 11. A discharge space 14 is filled with a plasma forming gas.

In the current embodiment, it is assumed that the summation result R+R of the red gray level data and the summation result B+B of the blue gray level data are overflowed in driving capability. In this case, the summation results R+R and B+B are reduced by a predetermined ratio, and are applied to the red cells and blue cells, respectively. Accordingly, it is necessary to compensate for the reduced summation results.

In order to compensate for the reduced summation results, in the current embodiment, the widths of the phosphor layers 16 applied to red address electrode lines A_{R1}, A_{R2}, . . . A_{Rm} and blue address electrode lines A_{B1}, A_{B2}, . . . , A_{Bm} are wider than the widths of phosphor layers 16 applied to green address electrode lines A_{G1}, A_{G2}, . . . , A_{G2m}. That is, the light-emitting areas of a red cell and a blue cell are wider than the light-emitting area of a green cell. In this regard, the ratio of the light-emitting area of a green cell to the light-emitting area of a red cell or a blue cell corresponds to the predetermined ratio. For example, if the summation results R+R and B+B are respectively reduced by half, the light-emitting area of a red cell or a blue cell is double the light-emitting area of a green cell.

When the plasma display panel 1 described above is driven, resetting, addressing and sustain-discharge operations are sequentially performed in a unit subfield. In the resetting operation, discharge distribution states of all cells become uniform. In the addressing operation, a predetermined wall voltage is created in selected cells. In the sustain-discharge operation, a predetermined AC voltage is applied to all XY electrode line pairs so as to sustain-discharge the cells in which the wall voltage has been created during the addressing operation. In the sustain-discharge operation, plasma is formed in the discharge spaces 14 (that is, gas layers) of the selected cells in which sustain-discharge has occurred, and thus the phosphor layers 16 are excited due to ultraviolet emission caused by the plasma, thereby emitting light.

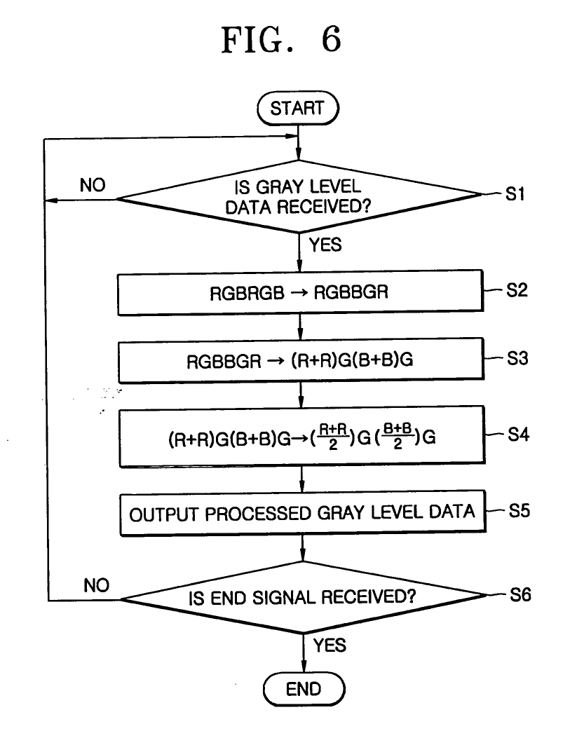

FIG. 6 is a flowchart illustrating an operation in which gray level data is processed by the controller illustrated in FIG. 1. The operation in which gray level data is processed by the controller 62 illustrated in FIG. 1 will be described below with reference to FIGS. 1, 2 and 6.

First, if gray level data corresponding to a conventional pixel structure 31 of red(R)-green(G)-blue(B)-red(R)-green(G)-blue(B) is inputted to the controller 62 from the image processor 66 (operation S1), the controller 62 rearranges the gray level data so that the gray level data corresponds to a virtual pixel structure 32 of red(R)-green(G)-blue(B)-blue(B)-green(G)-red(R) (operation S2).

Then, the controller 62 sums two red gray level data R which become adjacent to each other by the rearrangement, and sums two blue gray level data B which become adjacent to each other by the arrangement (operation S3).

As described above, it is assumed that the summation result R+R of the red gray level data R and the summation result B+B of the blue gray level data B are overflowed in driving capability. In this case, the summation results R+R and B+B are respectively reduced by a predetermined ratio, and the reduced summation results are applied to the red cells and blue cells, respectively. In the current embodiment, the controller 62 reduces the summation results R+R and B+B by half (operation S4).

As described above, in order to compensate for the summation results being reduced by half, the widths of phosphor layers 16 applied to red address electrode lines A_{R1}, A_{R2}, . . . , A_{Rm}, and blue address electrode lines A_{B1}, A_{B2}, . . . , A_{Bm}, are double the widths of phosphor layers 16 applied to green address electrode lines A_{G1}, A_{G2}, . . . , A_{Gm}. That is, the light-emitting areas of a red cell and a blue cell are double the light-emitting area of a green cell.

Then, the controller 62 outputs the processed gray level data to the address driver 63 (operation S5).

The controller 62 repeatedly performs the above-described operations until an external end signal (for example, a power off signal) is received (operation S6).

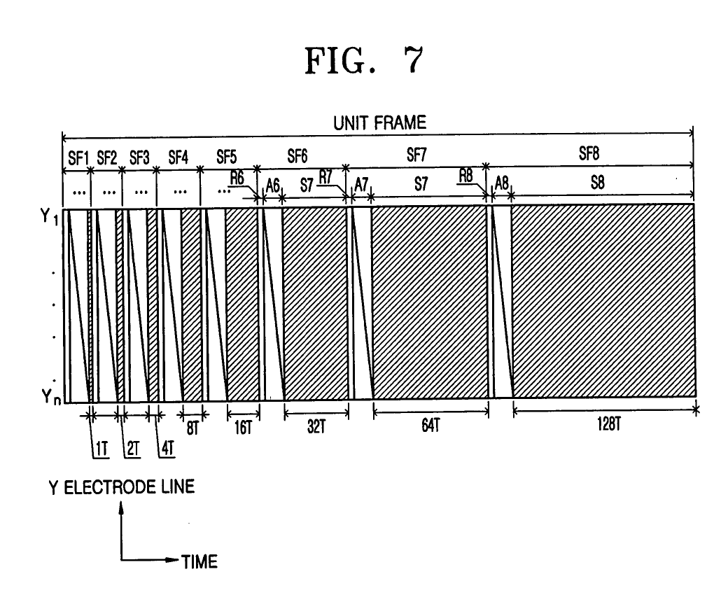

FIG. 7 is a timing diagram for explaining a method of driving the plasma display panel illustrated in FIG. 1.

Referring to FIG. 7, each unit frame is divided into eight subfields SF1, . . . , SF8 so as to implement time-division gray scale display. Each subfield SF1, . . . , SF8 is divided into a resetting period R1, . . . , R8, an addressing period A1, . . . , A8, and a sustain-discharge period S1, . . . , S8.

In the resetting period R1, . . . , R8, charge distribution states of all cells become uniform so as to be suitable for the following addressing.

In the addressing period A1, . . . , A8, display data signals are applied to the address electrode lines A_{R1}, A_{G1}, A_{B1}, A_{G2}, . . . , A_{G2m} and A_{Bm}, and corresponding scan pulses are sequentially applied to the respective Y electrode lines Y₁, . . . , Yₙ. Accordingly, if the display data signals go “high” while the scan pulses are applied, addressing discharge occurs in selected discharge cells, so that wall charges are formed in the selected discharge cells, and no wall charge is formed in non-selected discharge cells.

In the sustain-discharge period S1, . . . , S8, a sustain discharge pulse is alternately applied to all Y electrode lines Y₁, . . . , Yₙ and all X electrode lines X₁, . . . , Xₙ, so that sustain discharge occurs in the discharge cells in which wall charges have been formed. The brightness of the plasma display panel 1 is proportional to the length of the sustain-discharge periods S1, . . . , S8 in a unit frame. The length of the sustain-discharge periods S1, . . . , S8 in a unit frame is 255T (T is a unit time). Accordingly, a unit frame can be represented by 256 gradations, including 0 gradation which is not displayed in any subfield.

In the latter regard, the sustain-discharge period S1 of the first subfield SF1 is set to a time 1T corresponding to 20, the sustain-discharge period S2 of the second subfield SF2 is set to a time 2T corresponding to 21, the sustain-discharge period S3 of the third subfield SF3 is set to a time 4T corresponding to 22, the sustain-discharge period S4 of the fourth subfield SF4 is set to a time 8T corresponding to 23, the sustain-discharge period S5 of the fifth subfield SF5 is set to a time 16T corresponding to 24, the sustain-discharge period S6 of the sixth subfield SF6 is set to a time 32T corresponding to 25, the sustain discharge period S7 of the seventh subfield SF7 is set to a time 64T corresponding to 26, and the sustain discharge period S8 of the eighth subfield SF8 is set to a time 128T corresponding to 27.

Accordingly, by appropriately combining subfields to be displayed among the eight subfields, 256 gradations, including 0 gradation which is not displayed in any subfield, can be displayed.

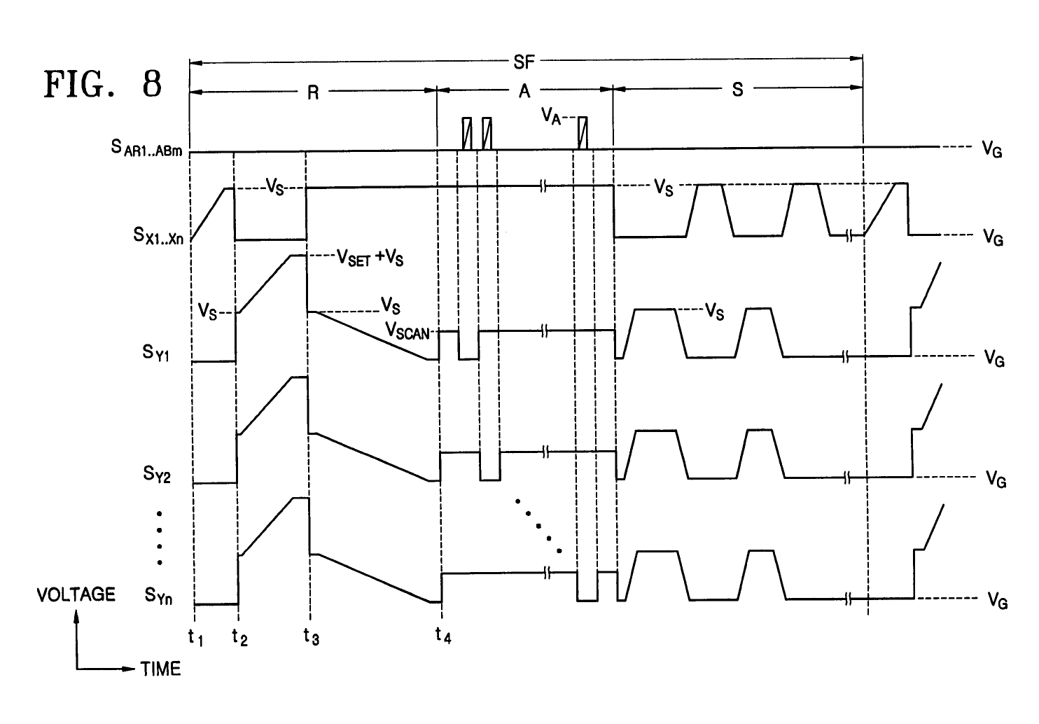

FIG. 8 shows waveform diagrams of signals applied to electrode lines of the plasma display panel illustrated in FIG. 1 in a unit subfield illustrated in FIG. 7.

In FIG. 8, a reference number S_{AR1}, . . . , A_{Bm} indicates a timing diagram of a driving signal applied to the address electrode lines A_{R1}, A_{G1}, A_{B1}, A_{G2}, . . . , A_{G2m} and A_{Bm}, a reference number S_{X1}, . . . , xₙ indicates a timing diagram of a driving signal applied to the X electrode lines X₁, . . . , Xₙ, and reference numbers S_{X1}, . . . , S_{Yn} indicate timing diagrams of driving signals applied to the respective Y electrode lines Y₁, . . . , Yₙ.

Referring to FIG. 8, in a first time t1-t2 of a resetting period R of a unit subfield SF, a voltage applied to the X electrode lines X₁, . . . , Xₙ gradually rises from a ground voltage V_{G} to a second voltage V_{SET}. At this point, the ground voltage V_{G} is applied to the Y electrode lines Y₁, . . . , Yₙ, and the address electrode lines A_{R1}, A_{G1}, A_{B1}, A_{G2}, . . . , A_{G2m} and A_{Bm}. Accordingly, a weak discharge occurs between the X electrode lines X₁, . . . , Xₙ and the Y electrode lines Y₁, . . . , Yₙ, and between the X electrode lines X₁, . . . , Xₙ and the address electrode lines A_{R1}, A_{G1}, A_{B1}, A_{G2}, . . . , A_{G2m} and A_{Bm}, so that negative wall charges are formed near the X electrode lines X₁, . . . , Xₙ.

In a second time t2-t3, which is a wall charge accumulating time, the voltage applied to the Y electrode lines Y₁, . . . , Yₙ gradually rises from the second voltage V_{SET} to a first voltage V_{SET}+V_{S} higher by a fourth voltage V_{S} than the second voltage V_{SET}. At this point, the ground voltage V_{G} is applied to the X electrode lines X₁, . . . , Xₙ and the address electrode lines A_{R1}, A_{G1}, A_{B1}, A_{G2}, . . . , A_{G2m} and A_{Bm}. Accordingly, a weak discharge occurs between the Y electrode lines Y₁, . . . , Yₙ and the X electrode lines X₁, . . . , Xₙ, and a weaker discharge occurs between the Y electrode lines Y₁, . . . , Yₙ and the address electrode lines A_{R1}, A_{G1}, A_{B1}, A_{G2}, . . . , A_{G2m} and A_{Bm}. In this regard, the reason that a discharge between the Y electrode lines Y₁, . . . , Yₙ and the X electrode lines X₁, . . . , Xₙ is stronger than a discharge between the Y electrode lines Y₁, . . . , Yₙ and the address electrode lines A_{R1}, A_{G1}, A_{B1}, A_{G2}, . . . , A_{G2m} and A_{Bm}, is that negative wall charges are formed near the X electrode lines X₁, . . . , Xₙ. Accordingly, a large amount of negative wall charge is formed near the Y electrode lines Y₁, . . . , Yₙ, positive wall charges are formed near the X electrode lines X₁, . . . , Xₙ, and a small amount of positive wall charge is formed near the address electrode lines A_{R1}, A_{G1}, A_{B1}, A_{G2}, . . . , A_{G2m} and A_{Bm}.

In a third time t3-t4, which is a wall charge distribution time, while the voltage applied to the X electrode lines X₁, . . . , Xₙ is maintained at the second voltage V_{SET}, the voltage applied to the Y electrode lines Y₁, . . . , Yₙ gradually falls from the second voltage V_{SET} to the ground voltage V_{G} which is a third voltage. In this regard, the ground voltage V_{G} is applied to the address electrode lines A_{R1}, A_{G1}, A_{B1}, A_{G2}, . . . , A_{G2m} and A_{Bm}. Accordingly, due to the weak discharge between the X electrode lines X₁, . . . , Xₙ and the Y electrode lines Y₁, . . . , Yₙ, some of the negative wall charges formed near the Y electrode lines Y₁, . . . , Yₙ move near the X electrode lines X₁, . . . , Xₙ. Accordingly, the wall electric-potential of the X electrode lines X₁, . . . , Xₙ is lower than the wall electric-potential of the address electrode lines A_{R1}, A_{G1}, A_{B1}, A_{G2}, . . . , A_{G2m} and A_{Bm} and is higher than the wall electric-potential of the Y electrode lines Y₁, . . . , Yₙ. Accordingly, an addressing voltage V_{A}-V_{G} required for opposite discharge between the Y electrode lines Y₁, . . . , Yₙ and address lines selected in the following addressing period A can be lowered. Meanwhile, since the ground voltage V_{G} is applied to all address electrode lines A_{R1}, . . . , A_{Bm}, the address electrode lines A_{R1}, A_{G1}, A_{B1}, A_{G2}, . . . , A_{G2m} and A_{Bm} perform a discharge with reference to the X electrode lines X₁, . . . , Xₙ and the Y electrode lines Y₁, . . . , Yₙ. Due to the discharge, the positive wall charges near the address electrode lines A_{R1}, A_{G1}, A_{B1}, A_{G2}, . . . , A_{G2m} and A_{Bm} are extinguished.

In the following addressing period A, a display data signal is applied to the address electrode lines A_{R1}, A_{G1}, A_{B1}, A_{G2}, . . . , A_{G2m} and A_{Bm}, and a scan signal with the ground voltage V_{G} is sequentially applied to Y electrode lines Y₁, . . . , Yₙ biased to a fifth voltage V_{S} which can lower than the second voltage V_{SET}, so that addressing is stably performed. The positive addressing voltage V_{A} is applied as a display data signal to address electrode lines A_{R1}, A_{G1}, A_{B1}, A_{G2}, . . . , A_{G2m} and A_{Bm} of selected cells, and the ground voltage V_{G} is applied as a display data signal to address electrode lines A_{R1}, A_{G1}, A_{B1}, A_{G2}, . . . , A_{G2m} and A_{Bm} of non-selected cells. Accordingly, if a display data signal of the positive addressing voltage V_{A} is applied to the selected cells while a scan pulse of the ground voltage V_{G} is applied to the non-selected cells, addressing discharge is generated so that wall charges are formed in the selected cells and no wall charge is formed in the non-selected cells. At this point, in order to more correctly and efficiently perform addressing discharge, the X electrode lines X₁, . . . , Xₙ are maintained at the second voltage V_{SET}.

In the following sustain discharge period S, sustain discharge pulses of the second voltage V_{SET} are alternately applied to all the Y electrode lines Y₁, . . . , Yₙ and X electrode lines X₁, . . . , Xₙ, so that a sustain discharge occurs in cells in which wall charges have been formed during the addressing period A.

As described above, in the display panel according to the present invention, the number of green cells in a pixel is double the number of red or blue cells in a pixel. The actual resolution which can be visually recognized by human beings is nearly proportional to the number of green cells having a relatively high brightness. Accordingly, in the display panel according to the present invention, the number of cells increases 4/3 times while the resolution is doubled, in contrast to the conventional display panel with the general pixel structure.

Accordingly, if the entire size and cell areas of the display panel 1 having the pixel structure 33 of green-red-green-blue are equal to the entire size and cell areas, respectively, of the conventional display panel, the actual resolution which can be visually recognized from the display panel 1 by human beings can increase 3/2 times compared to the resolution of the conventional display panel.

In addition, in the driving method of a display panel according to the present invention, a display panel with a pixel structure of green-red-green-blue can be driven using all gray level data of red-green-blue.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A display panel having a plurality of pixels, each of the pixels comprising two green cells, a red cell, and a blue cell, wherein one of the red cell and the blue cell is disposed between the two green cells.

2. The display panel of claim 1, wherein a light-emitting area of said one of the red cell and the blue cell is wider than a light-emitting area of the green cell.

3. A method of driving a display panel having a plurality of pixels, the display panel using red-green-blue gray level data with respect to each of the pixels, said each of the pixels comprising two green cells, a red cell and a blue cell, and one of the red cell and the blue cell being disposed between the two green cells, the method comprising the steps of:
(a) summing red gray level data for two adjacent pixels of the red-green-blue gray level data, and applying a red gray level data summation result to the red cell;
(b) applying green gray level data for the two adjacent pixels of the red-green-blue gray level data to the two green cells; and
(c) summing blue gray level data for the two adjacent pixels for the red-green-blue gray level data, and applying a blue gray level data summation result to the blue cell.

4. The method of claim 3, wherein steps (a), (b) and (c) are performed after gray level data arranged in an order of red-green-blue-red-green-blue are rearranged in an order of red-green-blue-blue-green-red.

5. The method of claim 4, wherein step (a) comprises summing two red gray level data which become adjacent by rearrangement, and applying a corresponding summation result to the red cell.

6. The method of claim 5, wherein step (a) further comprises reducing the corresponding summation result by a predetermined ratio, and applying the reduced corresponding summation result to the red cell.

7. The method of claim 4, wherein step (c) comprises summing two blue gray level data which become adjacent by rearrangement, and applying a corresponding summation result to the blue cell.

8. The method of claim 7, wherein step (c) further comprises reducing the corresponding summation result by a predetermined ratio, and applying the reduced corresponding summation result to the blue cell.
